(19) United States
(12) Patent Application Publication
(10) Pub. No.: US 2014/0100773 A1
(43) Pub. Date: Apr. 10, 2014

(54) Method of Assistance for the Visually Impaired

(71) Applicants: Briggs B. Cunningham, Chandler, AZ (US); Steven A. Lippert, Phoenix, AZ (US); Kenneth A. Hirsch, Scottsdale, AZ (US)

(72) Inventors: Briggs B. Cunningham, Chandler, AZ (US); Steven A. Lippert, Phoenix, AZ (US); Kenneth A. Hirsch, Scottsdale, AZ (US)

(73) Assignee: PRACTICAL INTELLECT, LLC, Chandler, AZ (US)

(21) Appl. No.: 13/646,702

(22) Filed: Oct. 7, 2012

(51) Int. Cl. G01C 21/00

(52) U.S. Cl. 701/431

(57) ABSTRACT

A method of providing assistance for the blind or otherwise visually impaired is provided. A user utilizes a mobile device to communicate with a remote operator in the event that the user is in need of assistance in orienting themselves with their surroundings or locating and viewing objects. The mobile device connects to a remote server through a data connection, providing audio, video, and other data communication with an operator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to methods of providing assistance for the blind or otherwise visually impaired.

2. Description of the Related Art

Many navigational markers and labels are designed specifically for those with no or limited impairments to their vision. Relatively few establishments place placards with words written in braille for the benefit of the blind or otherwise visually impaired. In order for the visually impaired to be able to navigate or read written material, few options are available allowing them to retain their independence.

When traveling through an unfamiliar area, the visually impaired frequently find the best method to ensure they are able to reach their destination quickly and easily is to be accompanied by another person without visual impairment. Although this ensures that someone is available to quickly see, navigate, and read for the person, the person is not always guaranteed that someone will be available to accompany them when the person needs them.

An alternative to having another individual accompany the visually impaired person is simply to stop passersby and ask questions, when assistance is needed. Unfortunately, the person cannot be sure that there will be a passerby that will be ready and willing to assist with their needs. This reliance on unknown people reduces the person's independence and mobility.

Alternatively, the visually impaired person may attempt to take a picture of the markings they need assistance viewing. This picture may then be sent to an assistant, who attempts to read the markings in the picture and reports back to the person by telephone. This largely depends on the accuracy of the visually impaired person's ability to accurately frame an image with the camera, focus the lens, and transmit the picture. Pictures are frequently taken with the desired markings out of frame or blurred. Additionally, this does not allow for real-time communication regarding the person's current surroundings.

A solution is needed to address one or more of these shortcomings in the prior art.

### BRIEF SUMMARY OF THE INVENTION

The present invention provides a method of providing assistance for the blind or otherwise visually impaired. Using the method, a user utilizes a mobile device to communicate with a remote operator in the event that the user is in need of assistance in orienting themselves with their surroundings or locating and viewing objects.

A mobile device, such as a mobile phone or tablet, is equipped at least one data chip set suitable to establish a mobile data connection. Such chip sets may allow a Wi-Fi, EDGE, 3G, 4G, or other mobile data network connection. This mobile data connection enables the mobile device to access other resources connected to the internet.

The mobile device is also able to determine its geographical location. This location my be found through use of a Global Positioning System (GPS) receiver, triangulation of signals from a data network, or other method of determining location.

The mobile device is further equipped with a camera. The camera is accompanied by a microphone and speakers. The camera and microphone together may capture and transmit, via the data chip set, an audiovisual stream. The microphone and speakers may be embedded in the mobile device or an external headset.

A remote assistance provider is provided, wherein the remote assistance provider comprises a video server connected to the internet. The video server receives the audiovisual stream produced by the mobile device and enables an operator to view and hear video and audio streams from the mobile device.

The remote assistance provider further comprises a data server. The data server acts as a bridge between the video server and a workstation.

When a user needs assistance in orienting themselves with their surroundings or locating and viewing objects, the user presses a button on the mobile device to establish a link with the video server and data server. Upon an established link between the mobile device, video server, and data server, the physical location of the mobile device is transmitted to the data server, along with mobile device identification information, such as a user's name or other identifier.

The operator is then informed, through the workstation, that assistance is being requested. The operator may view the audiovisual stream from the mobile device, as well as the user's location on a map. Through this connection, the operator may answer questions from the user and provide necessary guidance.

### BRIEF DESCRIPTION OF THE SEVERAL VIEWS OF THE DRAWING

FIG. 1 depicts an embodiment the method of assistance for the visually impaired in use.

FIG. 2 depicts an embodiment of the mobile device of the present invention.

FIG. 3 depicts an embodiment of the display of the workstation of the present invention.

### DETAILED DESCRIPTION OF THE INVENTION

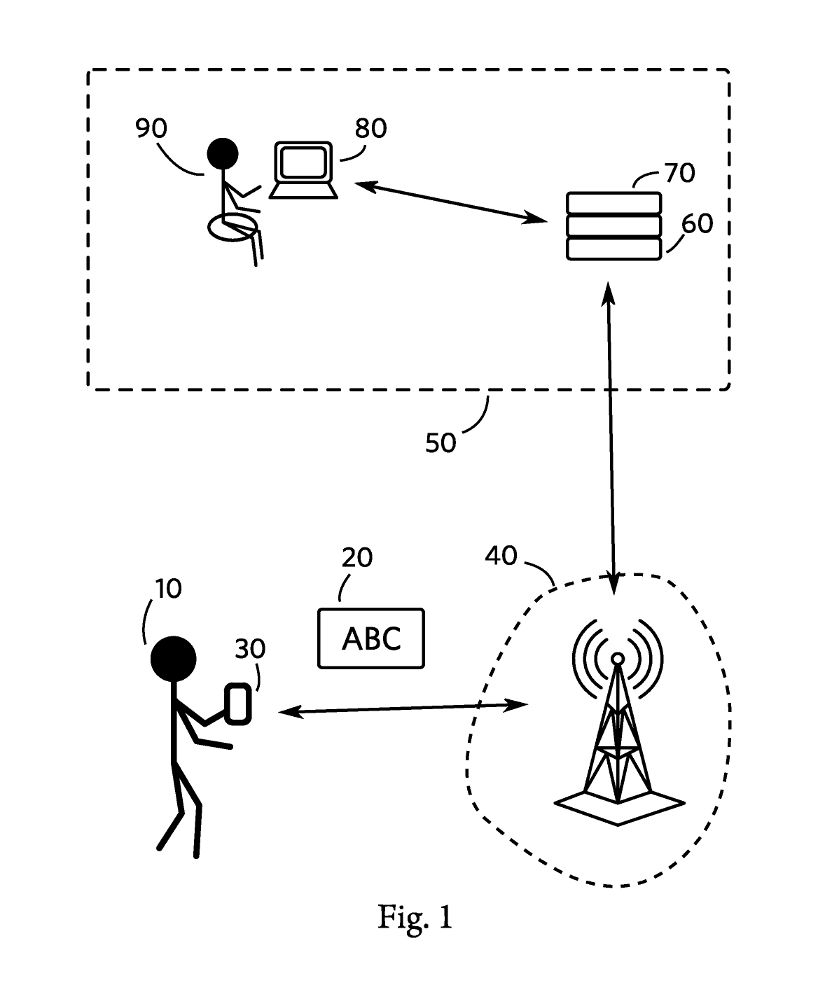

Referring now to FIG. 1, a user 10 utilizes a mobile device 30 to communicate with a remote assistance provider 50 in the event that the user 10 is in need of assistance in orienting themselves with their surroundings or locating and viewing visual markers 20, such as signs, labels, and landmarks.

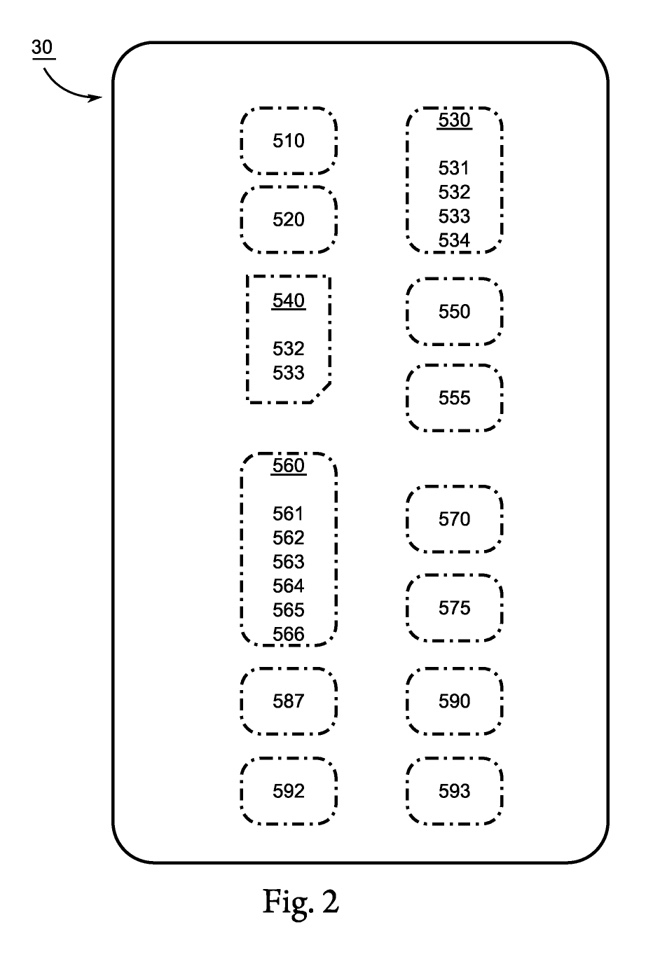

Referring now to FIG. 2, a mobile device 30, such as a mobile phone or tablet, is powered by a battery 585 and contains a processor 520. The mobile device 30 may have internal memory 530 or external memory 540 which hold software code, such as an operating system 531, communication system software 532, and software settings 533.

The mobile device 30 further comprises a display 550 and user interface 560, which may comprise a keypad 561, keyboard 562, touch screen 563, voice input 564, miscellaneous buttons 565, or trackball 566.

The mobile device 30 is further equipped with at least one data chip set 595 suitable to establish a mobile data connection. The data chip set 595 may allow a Wi-Fi, EDGE, 3G, 4G, or other mobile data network 40 connection. This mobile data connection enables the mobile device 30 to access other resources connected to the internet.

The mobile device 30 is also able to determine its geographical location. This location my be found through use of a Global Positioning System (GPS) receiver 590, triangulation of signals from a data network 40, or other method of determining location.

The mobile device 30 is further equipped with a camera 555. The camera 555 is accompanied by a microphone 575 and a speaker 570. The camera 555 and microphone 575 may together capture and transmit, via the data chip set 595, an audiovisual stream. The camera 555 is accompanied by a microphone 575 and a speaker 570, allowing for two-way audio conversation over the data connection. The microphone 575 and speakers 570 may be embedded in the mobile device 30 or accessed via an external headset connected through a bluetooth chip 580 or other data transfer method.

A remote assistance provider 50 is provided, wherein the remote assistance provider 50 comprises a video server 60 connected to the internet. The video server 60 receives the audiovisual stream produced by the mobile device 30 and enables an operator 90 to view and hear video and audio streams from the mobile device 30.

The remote assistance provider 50 further comprises a data server 70. The data server 70 acts as a bridge between the video server 60 and a workstation 80. The video server 60 and the data server 70 may optionally be a single server, or separate servers. If separate, video server 60 and the data server 70 may optionally be stored at a single location, or multiple locations.

A workstation 80 is provided which to the video server 60 and data server 70 to display information regarding the user 10 location and audiovisual stream. The workstation 80 may be a desktop computer, notebook computer, mobile device, or other device with a display 300, microphone, and internet connectivity.

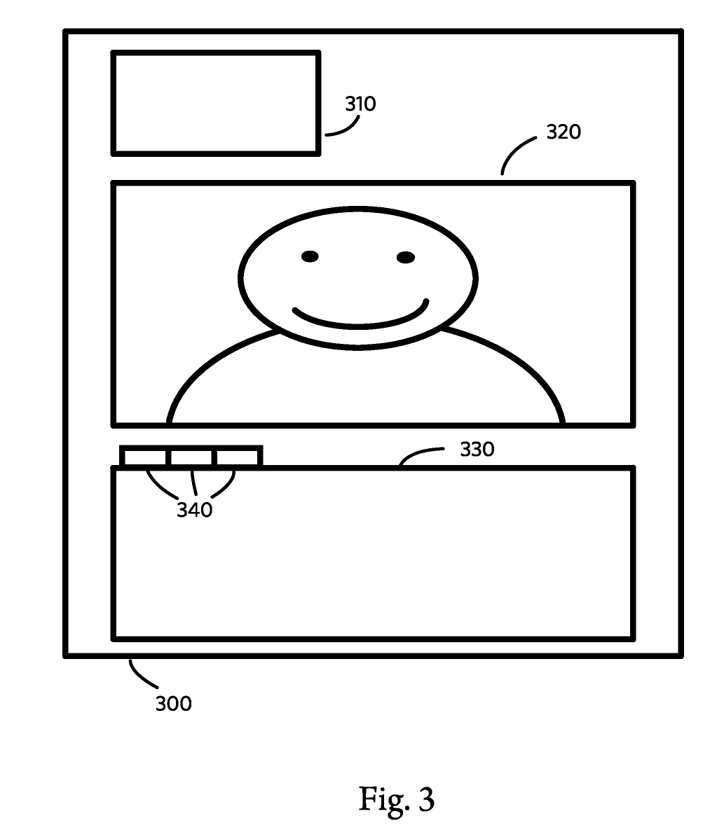

Referring now to FIG. 3, the display 300 on the workstation 80 may have a first display area 310, a second display area 320, and a third display area 330. Information may be displayed in each of the display areas 310, 320, 330 for the operator 90 to view. Information displayed in the display areas 310, 320, 330 may include user 10 information, the audiovisual stream, a map displaying user 10 location, or other information regarding the needs of the user 10. The display 300 may optionally contain tabs or buttons 340, which change the information displayed in the display areas 310, 320, 330 upon selection by the operator 90.

When a user 10 needs assistance in orienting themselves with their surroundings or locating and viewing visual markers 20, the user 10 presses activates an option in the user interface 560 of the mobile device 30 to establish a link with the video server 60 and data server 70. Upon an established link between the mobile device 30, video server 60, and data server 70, the physical location of the mobile device 30 is transmitted to the data server 70, along with mobile device 30 identification information, such as the name of a user 10 or other identifier.

The operator 90 is then informed, through a notification on the workstation 80, that assistance is being requested. The operator 90 may view the audiovisual stream from the mobile device 30, as well as the location of the user 30 on a map. Through this connection, the operator 90 may answer questions from the user 10 and provide necessary guidance.

The display 300 on the workstation 80 shows the operator 90 the audiovisual stream from the mobile device 30 as it is being sent to the video server 60. This allows the operator 90 to view the surroundings of the user 10 as they speak over the audio connection. If the visual marker 20 with which the user 10 requires assistance is not currently in the frame of the camera 555, the operator 90 may request that the user 10 reorient the mobile device 30 so that the visual marker 20 is in the frame of the camera 555.

In the event that the user 10 requires navigational assistance, the display 300 on the workstation 80 displays a map with the location of the user 10 in one of the display areas 310, 320, 330, provided by the GPS receiver 590, marked on the map. The operator 90 may then direct the user 10 along walkways and paths until the user 10 arrives at their desired destination.

In the event that the user 10 requires other assistance, the display areas 310, 320, 330 may alternatively allow the operator 90 to search for other required information through the internet.

In the event that the mobile device 30 has difficulty transmitting the audiovisual stream, while simultaneously receiving an audio stream from the operator 90 through the data network 40, the operator 90 audio stream may be terminated to preserve data network 40 bandwidth in an effort to ensure the operator 90 receives the highest quality audiovisual stream possible.

In the event that the operator 90 audio stream is terminated, the operator 90 may input text communication into the workstation 80, which is then transmitted through the data server 70 to the mobile device 30. The mobile device 30 then utilizes text-to-speech (TTS) software to read the text communication to the user 10. The mobile device 30 may alternatively connect to a braille display, which the user 10 may use to read the text communication.

Once the user 10 no longer requires assistance, the user 10 or operator 90 can terminate communication between the mobile device 30 and the video server 60 and data server 70.

The operator 90 may be one of several operators 90 grouped together as a call center for the remote assistance provider 50. It should be understood that any one or more of the several operators 90 and their associated workstations 80 may be located either at or apart from a facility with the video server 60 or the data server 70. By having several operators 90 available, the user 10 is ensured that an operator 90 will be available when assistance is required to view visual markers 20.

If several operators 90 are available, the remote assistance provider 50 may optionally select an operator 90 which has had multiple past interactions with the user 10. This allows the user 10 and operator 90 to become more familiar with the needs of the user 10 and allow for speedy assistance.

We claim:

1. A method for assisting a visually impaired person comprising the steps of:
(A) providing a mobile device, the mobile device comprising
(i) a processor,
(ii) a camera,
(iii) a user interface,
(iv) a speaker,
(v) a microphone,
(vi) a data chip set, and
(vii) a GPS receiver;
(B) providing a data network;
(C) providing a remote assistance provider, the remote assistance provider comprising
(i) one or more video servers,
(ii) one or more data servers, and
(iii) one or more workstations;
(D) establishing a connection between the mobile device, a video server, and a data server through the data network;
(E) transmitting an audiovisual stream from the mobile device to the video server;
(F) displaying the audiovisual stream on the workstation;
(G) transmitting location coordinates from the mobile device to the data server;
(H) displaying the location coordinates on the workstation; and
(I) utilizing the audiovisual stream or the location coordinates to assist the visually impaired person with orientation, locating items, or visual recognition.

2. The method of claim 1, further comprising the steps of:
(A) transmitting text data through the data network from the workstation to the mobile device; and
(B) utilizing text-to-speech software on the mobile device to read the text data to the visually impaired person.

3. The method of claim 1, further comprising the steps of:
(A) transmitting text data through the data network from the workstation to the mobile device; and
(B) utilizing a braille display to display the text data for the visually impaired person.

4. The method of claim 1, wherein one or more of the camera, the microphone, and the speaker are housed separately from the processor, and are able to transmit data to the processor by a data connection.

5. The method of claim 4, further comprising the steps of:
(A) transmitting text data through the data network from the workstation to the mobile device; and
(B) utilizing text-to-speech software on the mobile device to read the text data to the visually impaired person.

6. The method of claim 4, further comprising the steps of:
(A) transmitting text data through the data network from the workstation to the mobile device; and
(B) utilizing a braille display to display the text data for the visually impaired person.
